(19) United States
(12) Patent Application Publication
(10) Pub. No.: US 2007/0145129 A1
(43) Pub. Date: Jun. 28, 2007

(54) System and method for identifying equipment

(76) Inventors: Gregg Steven Perkin, Kingwood, TX (US); Keven Michael O'Connor, Houston, TX (US); John Hadjioannou, Spring, TX (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 11/318,772

(22) Filed: Dec. 27, 2005

(51) Int. Cl. G06Q 30/00; G06K 7/08; G06K 19/06

(52) U.S. Cl. 235/385; 235/451; 235/492

(57) ABSTRACT

An apparatus for identifying oilfield tubular assets. A ring having an inner diameter is supported within the inner diameter of the tubular asset so that the inner diameter of the ring is substantially flush with the inner diameter of the tubular asset. At least one electronic circuit supported by the ring and adapted to transmit a unique identification code to a portable receiver. The portable receiver may have a display to communicate identity of the tubular asset. The portable receiver may display tubular asset maintenance and usage records stored at a central location or at the electronic circuit.

### FIELD OF THE INVENTION

The present invention relates generally to the field of identification devices, and more specifically to the use of radio frequency identification devices to track and inventory oilfield equipment.

### SUMMARY OF THE INVENTION

The present invention is directed to an apparatus for identifying an oilfield tubular asset having an inner diameter. The apparatus comprises a ring having an inner diameter, a circuit supported by the ring, and a portable receiver. The ring is supported within the tubular asset such that the inner diameter of the ring is substantially flush with the inner diameter of the tubular asset. The circuit is supported within the ring and adapted to transmit at least an identification code. The portable receiver is adapted to receive the unique identification code transmitted by the circuit.

The present invention further includes a method for managing usage and maintenance records of tubular assets. The method comprises affixing a circuit within a tubular asset such that the inner diameter of the circuit is substantially flush with the inner diameter of the tubular asset, activating the circuit to transmit at least an identification code, receiving the identification code, and displaying usage and maintenance records of the tubular asset.

Further still, the present invention includes an apparatus for identifying an oilfield tubular asset. The apparatus comprises an active circuit, a means for supporting the active circuit and for securing the active circuit to the tubular asset, and a portable receiver. The active circuit is adapted to transmit at least an identification code. The portable receiver is adapted to receive the unique identification code transmitted by the circuit, wherein the identification code is indicative of usage and maintenance records related to the tubular asset.

### DESCRIPTION OF THE FIGURES

FIG. 1 is diagrammatic representation of a portable receiver having an antenna and a hand-held receiver housing. The antenna is shown configured for insertion into the internal passages of a tubular asset. FIG. 2 is a partial sectional view of the tubular asset shown in FIG. 1. The tubular asset of FIG. 2 is shown with a radio frequency identification (hereinafter “RFID”) ring disposed within the pin end of the tubular asset.

FIG. 3a is an isometric view of the RFID ring shown in FIG. 2.

FIG. 3b is a cross-sectional view of the RFID ring of FIG. 3a showing a plurality of electronic circuits disposed about the circumference of the ring.

FIG. 4 is an isometric, exploded view of an alternative RFID ring having a circumferential groove and a generally rounded body.

FIG. 5 illustrates two alternative methods of positioning an electronic circuit within the tubular asset. In the first position, the circuit may be placed within a bore drilled from outside the tubular asset. In the second position, the circuit may be placed within a cavity drilled into the internal passage of the tubular asset.

FIG. 6 is a diagrammatic view of an internal boring machine used to create the cavity shown in FIG. 5.

### DESCRIPTION OF THE PREFERRED EMBODIMENTS

The development of oilfields requires the use of many different types of equipment related to exploration, development and completion. This equipment may cost several thousands of dollars to purchase, repair or replace. Accordingly, many pieces of oilfield equipment are used and reused. Such equipment, such as drill pipe and drill bits, may be placed under extreme amounts of stress that may eventually cause equipment failure. Thus, the industry has developed methods and systems designed to track the usage and service records of oilfield equipment. However, there remains a need for improvement.

The system 10 disclosed herein provides an apparatus and method for identifying oilfield equipment and maintaining usage and maintenance records. The system as described herein includes a portable receiver 12 adapted to identify oilfield equipment at or remote from the jobsite. Preferably, the portable receiver comprises a hand-held receiver and antenna adapted to identify tubular assets comprising drill pipe stacked on a pipe rack.

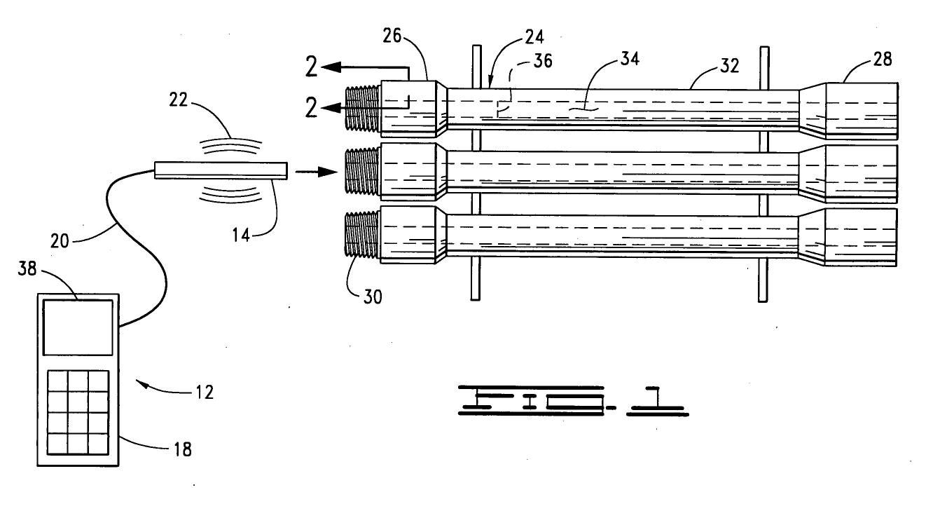

Turning now to the figures and in particular to FIG. 1, there is shown therein the system 10 for identifying oilfield tubular assets. The system 10 comprises the portable receiver 12. The portable receiver 12 comprises an elongate antenna 14 adapted to receive a unique identification code from an RFIDR ring 16 (FIG. 2). The elongate antenna 14 may be connected to a hand-held receiver housing 18 by a wire 20. However, it will be appreciated that the elongate antenna 14 and housing 18 of the portable receiver 12 may be integrally formed without departing from the spirit of the present invention. The elongate antenna 14 may be adapted to transmit a signal 22 to the RFID ring 16 supported by a drill pipe 24 and to receive the unique identification card from the electronic circuit 16 (FIG. 2).

The drill pipe sections 24 shown in FIG. 1 are preferably tubular having a pin end 26 and a box end 28. The pin end 26 and the box end 28 are correspondingly threaded. The pin end 26 is provided with tapered external threads 30, and the box end 28 is provided with tapered internal threads (not shown). Thus, box end 28 of the drill pipe 24 is connectable to the pin end 26 of a like pipe section. Similarly, the pin end 26 is connectable to the box end 28 of a like pipe section 24. The external diameter of the pin end 26 and the box end 28 of the drill pipe 24 may be larger than the external diameter of the central body portion 32 of the drill pipe. An internal passage 34 having an internal diameter 36 is formed within the drill pipe 24 and extends from the box end 28 to the pin end 26. The internal passage 34 may be used to transport fluids through the drill pipe and into a drill hole (not shown).

Continuing with FIG. 1, the portable receiver 12 may comprise the receiver housing 18. The housing 18 may have a display 38 and a keypad 40 for the input of information into the system. The display 38 may comprise a liquid crystal display adapted to display maintenance and usage records.

Turning now to FIG. 2, there is shown therein the pin end 26 of the drill pipe section 24 shown in FIG. 1. As previously discussed, the pin end 26 of the drill pipe section 24 comprises tapered external threads 30 and the inner diameter 36. The pin end 26 shown in FIG. 2 has been sectioned along the longitudinal axis 38 of the drill pipe section 24 and fragmented for ease of illustration. The pin end 26 of the drill pipe section 24 may comprise a groove 40 for maintaining the RFID ring 16 therein. This groove 40 may be cut into the inner diameter 36 of the drill pipe 24 using a cutting device (not show). The cutting device is adapted to cut the groove 40 in the drill pipe 24 equal to the width 42 and depth 44 of the RFID ring 16.

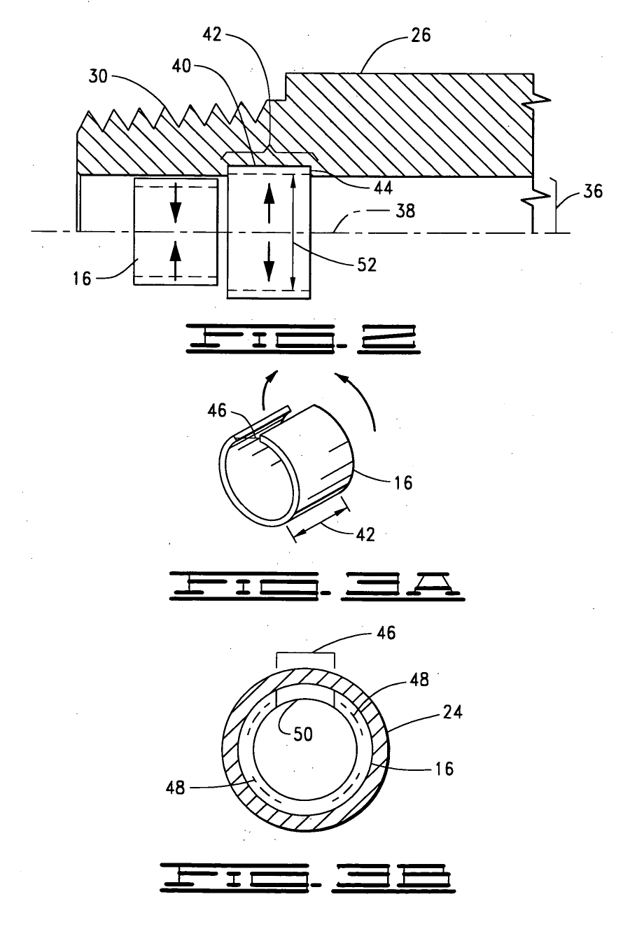

The RFID ring 16 may comprise a split circumferential ring comprised of a flexible material. As shown in FIG. 3a, the RFID ring 16 may comprise a gap 46 that allows for compression of the ring before installation into the drill pipe section 24. An electronic circuit 48 (FIG. 3b) is supported within the RFID ring 16 and adapted to transmit at least a unique identification code. Preferably, the RFID ring 16 may comprise a plurality of electronic circuits 48 disposed circumferentially about the RFID ring also adapted to transmit a unique identification code. It will be appreciated by one of skill in the art that the electronic circuit may comprise a passive circuit similar to that disclosed in U.S. Pat. No. 4,818,855, the contents of which are incorporated herein by reference. The passive circuit is adapted to transmit the unique identification code to the portable receiver 12 in response to being energized by the tuned magnetic field 22 transmitted by the portable receiver antenna 14. The portable receiver 12 receives the unique identification code and accesses a database to allow retrieval of or input of usage and status information of the oilfield equipment corresponding to the received identification code. It will be further appreciated by one skilled in the art that the electronic circuit 48 may comprise an active circuit comprising a power source that is activated by reception of the tuned magnetic field 22. The use of an active circuit provides the ability of read/write memory capable of carrying information from jobsite to jobsite on the drill pipe 24 without the need for a central database. For example, the active circuit 48 could store information relating to usage and maintenance. Further, the active circuit 48 having a power source will be capable of transmitting the unique identification code over greater distances than the previously described passive circuit.

Turning now to FIG. 3b, the RFID ring 16 of the present invention is illustrated in cross section. The RFID ring 16 is shown installed within the drill pipe section 24 with the gap 46 filled-in to prevent movement of the installed ring. A filler material 50 such as an epoxy capable of withstanding the harsh downhole environment may be used to fill-in the RFID ring gap 46.

The RFID ring of FIGS. 2-3 may be installed by first cutting away drill pipe material from the inner diameter 36 of the drill pipe section 24 to a depth 44 equal to the thickness of the RFID ring 16. The RFID ring 16 is then compressed so that the gap 46 is closed and the RFID ring is inserted into the pin end 26 of the pipe as shown at Position A (FIG. 2). The RFID ring 16 is inserted further into the pin end 26 of the drill pipe section 24 until it is inserted into the groove 40. Next, the filler material 50 may be inserted into the RFID ring gap 46 to lock the RFID ring 16 into the groove. It will now be appreciated that the RFID ring 16 is installed into the groove 40 so that the inner diameter 52 of the RFID ring is substantially flush with the inner diameter 52 of the tubular asset 24.

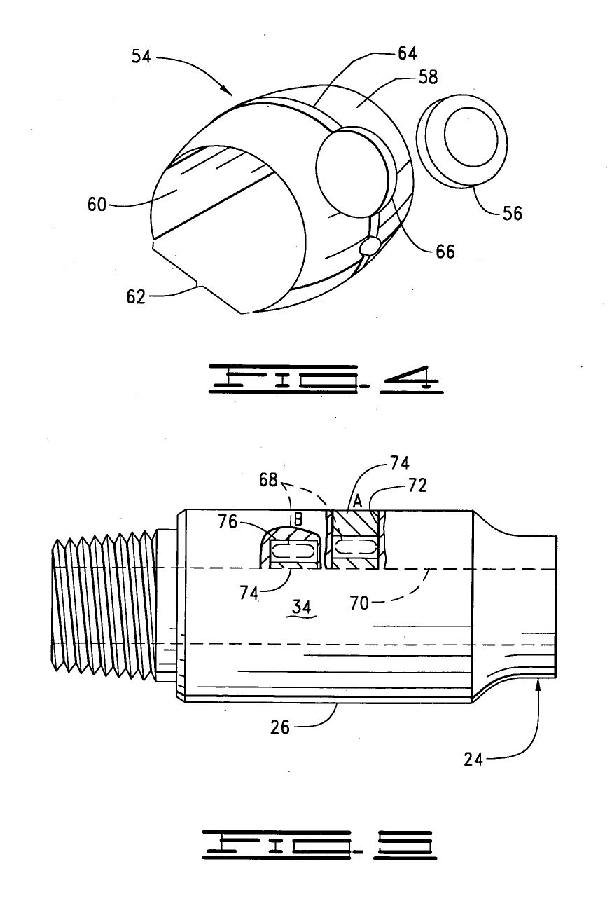

Turning now to FIG. 4 there shown therein an alternative RFID ring 16 comprising an electronic circuit 56. The RFID ring 54 of FIG. 4 may be manufactured from any material capable of withstanding the harsh downhole environment during drilling operations. Such materials may include non-ferrous metals or thermoplastics. The ring 54 comprises a generally rounded upper face 58, a flat lower face 60 and a gap 62. The rounded upper face 58 comprises a circumferential groove 64 adapted for mating engagement with a corresponding lip (not shown) formed in the internal groove 40 cut in the drill pipe section. The gap 62 allows for compression of the RFID ring's 54 diameter so that the ring may be placed within the internal passage 36 (FIG. 2) of the drill pipe section 24. The filler material 50 may be placed within the gap 62 after placement of the RFID ring 54 within the drill pipe 24 to prevent movement of the ring. The circumferential groove 64 also provides a means for preventing slippage or movement of the RFID ring 54 by matingly engaging a lip (not shown) in the groove 40 (FIG. 2) of the pipe section 24 (FIG. 2). The RFID ring 54 also comprises a socket 66 formed for mating engagement with the electronic circuit 56. The electronic circuit 56 may be maintained within the socket 66 using a suitable adhesive or other mechanical means.

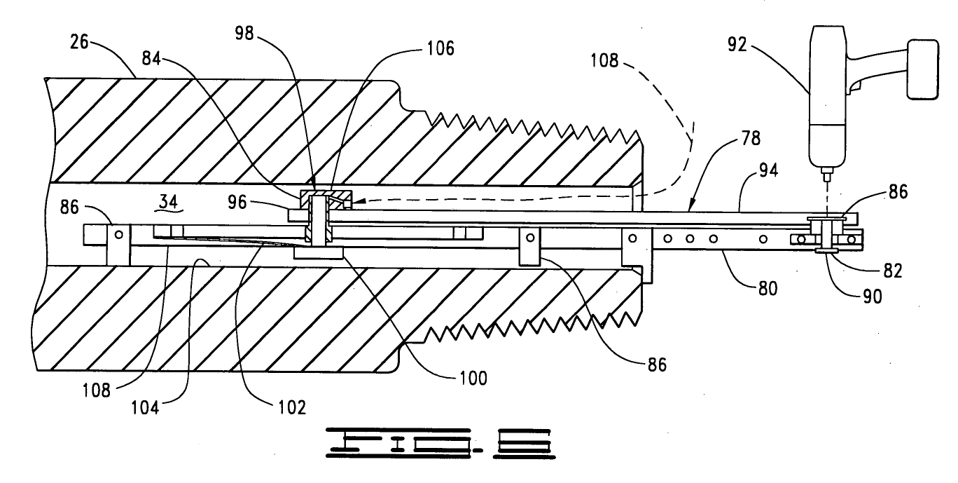

Turning now to FIG. 5 there is shown therein an alternative embodiment of the present invention. The embodiment of FIG. 5 shows the use of an encapsulated electronic circuit 68 supported within the sidewall 70 of the pin end 26 of the drill pipe section 24. The electronic circuit 68 may comprise an encapsulated circuit as taught in U.S. Pat. No. 5,142,128 issued to Perkin et al., the contents of which are incorporated by reference. The electronic circuit 68 is shown in FIG. 5 placed in two alternative positions A and B. In Position A the electronic circuit 68 is shown placed within borehole 72 drilled into the pin end 26 of the drill pipe section 24. The circuits 68 are installed on the interior of the pin end 26 so that the circuits may communicate with the antenna 14 (FIG. 1) of the portable receiver 12 when the antenna is placed within the internal passage 34. The filler material 74 may be placed in the borehole 72 to seal the hole and secure the circuit 68 within the borehole. In the alternative, the electronic circuit 68 may be placed within a cavity 76 drilled into the pin end 26 of the drill pipe section 24 from the internal passage 34 of the drill pipe. The cavity 76 may be cut into the pin end 26 of the drill pipe section 24 using an internal boring machine 78 illustrated in FIG. 6. The cavity 76 is then sealed using any commercially available sealant or filler material 74. It will be appreciated that several electronic circuits 68 may be placed about the circumference of the internal passage 34 to decrease directional sensitivity.

Turning now to FIG. 6, there is shown therein an internal boring machine 78 adapted to drill a cavity 76 in the internal passage 34 of a drill pipe section 24. The internal boring machine 78 of FIG. 6 is shown disposed within the internal passage 34 of the pin end of the drill pipe section. The boring machine 78 comprises a frame 80, a drive system 82 and a cutter assembly 84 both supported by the frame. The frame 80 is generally elongate and comprises support rails disposed in parallel alignment. A plurality of inner diameter stabilizers 86 are disposed between the rails 80 to stabilize the boring machine 78 within the internal passage 34.

The drive system 82 comprises a sprocket 88 having an internal shaft 90 adapted for engagement with the shaft of a commercially available portable drill 92. The drive system sprocket 88 engages a drive chain 94 that is driven in response to rotation of the drive sprocket 88. The drive chain 94, in turn, drives operation of the cutter assembly 84.

The cutter assembly 84 may comprise a cutter sprocket 96, an internal diameter stabilizer 98 and an actuable cutter 100 having a shaft 102. The cutter sprocket 96 is rotatable in response to movement of the drive chain 94. Rotation of the cutter sprocket 96 drives rotation of the cutter 100. The cutter 100 is extendable axially from the frame 80 to engage the surface 104 of the inner diameter of the pipe section 24 in response to a hydraulic fluid pumped into the cutter housing 106. The hydraulic fluid is supplied to the cutter assembly 84 via a hose 108 and extends the cutter 100 by generating pressure on the shaft 102 of the cutter 100. As the cutter 100 is extended from the frame 80, the cutter assembly stabilizer 98 is forced upward to engage the opposite side of the internal passage 34. The force placed on the internal passage 34 by the cutter 100 and the cutter stabilizer 98 hold the machine in place during operation. The hydraulic pressure generated within the cutter assembly housing 106 continues to force the cutter 100 axially from the frame 80 as the drilling operation proceeds. After the cavity 76 (FIG. 5) has been drilled in the internal passage 34, the hydraulic fluid is drained from the cutter assembly 84 and the cutter 100 retracts under the force of a leaf spring 108. Once the cutter 100 has been retracted, the boring machine 78 may be removed from the drill pipe 24 and the electronic circuit 68 (FIG. 5) installed in the newly created cavity 76.

The present invention is further directed to a method for managing usage and maintenance records of oilfield tubular assets 24. The method comprises affixing one of the previously described circuits within the tubular asset 24 such that an inner diameter of the circuit is substantially flush with the inner diameter of the tubular asset. The circuit 48, 68 is activated to transmit the at least one identification code. The identification code is then received by the portable receiver 12 and in response thereto the usage and maintenance records of the tubular asset 24 are displayed.

The method further includes storing the usage and maintenance records at a central location comprising either the CPU of the portable receiver 24 or at a remote computer. If stored at a remote computer, the usage and maintenance records of the tubular asset 24 may be transmitted from the remote computer disposed at the central location before displaying the usage and maintenance records. The usage and maintenance records may be displayed on the display 38 of the portable receiver 12 upon receipt of the unique identification code from the circuit 48, 68.

The method of the present invention may further include creating a new usage or maintenance record for the tubular asset 24 and storing the new usage or maintenance record in the remote computer disposed at the central location.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that within the scope of the appended claims, the invention may be practiced otherwise than as specifically illustrated and described.

What is claimed is:

1. An apparatus for identifying an oilfield tubular asset, the tubular asset having an inner diameter, the apparatus comprising:
a ring having an inner diameter, the ring being supported within the tubular asset such that the inner diameter of the ring is substantially flush with the inner diameter of the tubular asset;
at least an electronic circuit supported by the ring and adapted to transmit at least a unique identification code; and
a portable receiver adapted to receive the unique identification code transmitted by the circuit.

2. The apparatus of claim 1 wherein the ring comprises a circumferential ring.

3. The apparatus of claim 1 wherein the ring comprises a split ring.

4. The apparatus of claim 1 wherein the tubular asset comprises a groove formed therein and wherein the ring is disposed within the groove.

5. The apparatus of claim 1 further comprising a second electronic circuit supported within the ring and adapted to transmit a second unique identification code.

6. The apparatus of claim 1 wherein the portable receiver comprises an elongate antenna adapted to receive the unique identification code from the circuit.

7. The apparatus of claim 1 wherein the identification code is transmitted to the receiver using an electromagnetic signal.

8. The apparatus of claim 1 wherein the portable receiver comprises a transmitting antenna adapted to transmit a signal to the electronic circuit and a receiving antenna adapted to receive signals from the electronic circuit, wherein both the transmitting antenna and the receiving antenna have a diameter less than the inner diameter of the ring.

9. The apparatus of claim 8 wherein the portable receiver comprises a processor adapted to store at least a record related to the tubular asset, to process the identification code received by the receiving antenna, and to update the stored record in response to a user input.

10. The apparatus of claim 1 comprising a plurality of electronic circuits supported within the ring.

11. The apparatus of claim 1 wherein the portable receiver comprises a transmitting antenna adapted to transmit an electronic circuit activating signal and wherein the electronic circuit transmits the at least one unique identification code in response to the electronic circuit activating signal.

12. The apparatus of claim 1 wherein the portable receiver comprises a transceiver assembly adapted to transmit an electronic circuit activation signal and to receive the unique identification code from electronic circuit, wherein the transceiver has a diameter less than the inner diameter of the ring.

13. A method for managing usage and maintenance records of oilfield tubular assets, the method comprising:
affixing a circuit within a tubular asset such that an inner diameter of the circuit is substantially flush with an inner diameter of the tubular asset;
activating the circuit to transmit at least an identification code;
receiving the identification code; and
displaying usage and maintenance records of the tubular asset.

14. The method of claim 13 further comprising storing the usage and maintenance records at a central location.

15. The method of claim 13 further comprising transmitting usage and maintenance records to the central location.

16. The method of claim 13 further comprising receiving usage and maintenance records of the tubular asset from a central location before displaying said usage and maintenance records.

17. The method of claim 13 further comprising creating a new usage or maintenance record and storing the new usage or maintenance record in a central location.

18. The method of claim 13 further comprising visually displaying the usage and maintenance records of the tubular asset on a portable receiver assembly that is adapted to receive the unique identification code and display the maintenance and usage records.

19. An apparatus for identifying an oilfield tubular asset, the apparatus comprising:
an circuit assembly adapted to transmit at least a unique identification code indicative of usage and maintenance records related to the tubular asset, wherein the electronic circuit comprises an active electronic circuit and a passive circuit adapted to activate the active circuit;
a means for supporting the circuit assembly and for securing the active circuit to the tubular asset; and
a portable receiver adapted to activate the passive circuit and to receive the unique identification code transmitted by the circuit.

20. The apparatus of claim 19 wherein the means for supporting the active circuit comprises a split ring adapted to fit within an inner diameter of the tubular asset.

21. The apparatus of claim 20 further comprising a second circuit supported within the ring and adapted to transmit a second unique identification code.

22. The apparatus of claim 19 wherein the tubular asset comprises a groove formed therein and wherein the means for supporting the active circuit is disposed within the groove.

23. The apparatus of claim 19 wherein the portable receiver comprises an elongate antenna adapted to receive the unique identification code from the circuit.

24. The apparatus of claim 19 wherein the identification code is transmitted from the active circuit to the portable receiver using an electromagnetic signal.

25. The apparatus of claim 19 wherein the portable receiver comprises a transmitting antenna adapted to transmit a signal to the circuit and a receiving antenna adapted to receive signals from the circuit, wherein both the transmitting antenna and the receiving antenna have a diameter less than the inner diameter of the ring.

26. The apparatus of claim 25 wherein the portable receiver comprises a processor adapted to store at least a record related to the tubular asset, to process the identification code received by the receiving antenna, and to update the stored record in response to a user input.

27. The apparatus of claim 19 wherein the means for supporting the active circuit supports the active circuit about an outer diameter of the tubular asset.

28. The apparatus of claim 19 wherein the means for supporting the active circuit is constructed to support a plurality of active circuits.

29. The apparatus of claim 19 wherein the means for supporting the circuit assembly and for securing the active circuit to the tubular asset comprises a circumferential ring.

30. The apparatus of claim 19 wherein the portable receiver comprises a transceiver assembly adapted to transmit a circuit activation signal and to receive the unique identification code from the electronic circuit, wherein the transceiver has a diameter less than the inner diameter of the ring.
